(19) United States
(12) Patent Application Publication
(10) Pub. No.: US 2024/0310614 A1
(43) Pub. Date: Sep. 19, 2024

(54) ARRAY OBJECTIVE LENS MODULE AND OPTICAL INTERFERENCE MICROSCOPY SYSTEM

(71) Applicant: Industrial Technology Research Institute, Hsinchu (TW)

(72) Inventors: Chang Huang, New Taipei City (TW); Ying-Hao Wang, Hsinchu County (TW); Hsing-Wei Huang, Hsinchu City (TW); Chia-Jung Chang, Yunlin County (TW)

(73) Assignee: Industrial Technology Research Institute, Hsinchu (TW)

(21) Appl. No.: 18/544,446

(22) Filed: Dec. 19, 2023

Related U.S. Application Data
(60) Provisional application No. 63/452,701, filed on Mar. 17, 2023.

(30) Foreign Application Priority Data
Oct. 18, 2023 (TW) 112139742

(51) Int. Cl. G02B 21/00; G02B 21/02; G02B 25/00

(52) U.S. Cl. CPC G02B 21/0032; G02B 21/0056; G02B 21/02; G02B 25/001

(57) ABSTRACT

An array objective lens module, having an optical axis and including a substrate, multiple lens frames, and multiple objective lens sets is provided. The substrate includes multiple accommodating vias. Each accommodating via includes an internal thread structure. The lens frames are respectively disposed in the accommodating vias. Each lens frame includes an external thread structure. The external thread structure is adapted to the internal thread structure. The objective lens sets are respectively disposed in the lens frames. Each objective lens set includes at least one lens, and a relative position of each frame and the substrate in an extension direction of the optical axis changes according to a relative rotation angle of the corresponding external read structure and internal thread structure.

### CROSS-REFERENCE TO RELATED APPLICATION

This application claims the priority benefit of U.S. provisional application Ser. No. 63/452,701, filed on Mar. 17, 2023, and Taiwan application serial no. 112139742, filed on Oct. 18, 2023. The entirety of each of the above-mentioned patent applications is hereby incorporated by reference herein and made a part of this specification.

### TECHNICAL FIELD

The disclosure relates to an optical module and a microscopy device, and in particular to an array objective lens module and an optical interference microscopy system.

### BACKGROUND

In the future market demand, with the widespread application of advanced packaging chips, High Performance Computing (HPC) chip will gradually become the mainstream of the market. HPC Chips usually need to integrate multiple computing units such as High Bandwidth Memory (HBM) and other chiplets, so it will be integrated into a large chip in size. Traditional detection method will be limited to the detection speed and cannot be used for this detection. Therefore, providing fast and accurate 3D shape detection equipment is in strong demand.

Currently, the detection technique of white light interference can reach nanometer-level precision, but the detection speed of known white light interference equipment is very limited. In the solution that uses multiple lens for detection, it always needs multiple additional components to be equipped for scanning, so the construction cost of the whole equipment is quite high. In addition, for implementing simultaneous scanning, the coplanarity of each elements in the multi-lens structure must be consistent to make the white light coherence length less than or equal to 10 μm and meet specification. However, the insufficient processing precision of the existing optical clamping mechanism causes the coplanarity of the lens elements is far greater than 10 μm, so simultaneous scanning cannot be implemented to expand the field of view by using array lens for speeding up online detection.

### SUMMARY

The disclosure provides an array objective lens module, which has an optical axis and includes a substrate, multiple lens frames, and multiple objective lens sets. The substrate includes multiple accommodating vias. Each accommodating via includes an internal thread structure. The lens frames are respectively disposed in the accommodating vias. Each lens frame includes an external thread structure. The external thread structure is adapted to the internal thread structure. The objective lens sets are respectively disposed in the lens frames. Each objective lens set includes at least one lens, and a relative position of each lens frame and the substrate in an extension direction of the optical axis changes according to a relative rotation angle of the corresponding external thread structure and internal thread structure.

The disclosure also provides an optical interference microscopy system for imaging a to-be-measured object. The optical interference microscopy system includes a light source module, a second light splitter, an array objective lens module, a lens barrel module, and at least one imaging element. The light source module is used to provide an illumination beam. The second light splitter is disposed on a transmission path of the illumination beam from the light source module and is used to reflect the illumination beam and allow a measuring beam to pass through. The array objective lens module is disposed on the transmission path of the illumination beam from the second light splitter to the to-be-measured object. The array objective lens module has an optical axis and includes a substrate, multiple lens frames, and multiple objective lens sets. The substrate includes multiple accommodating vias. Each accommodating via includes an internal thread structure. The lens frames are respectively disposed in the accommodating vias. Each lens frame includes an external thread structure. The external thread structure is adapted to the internal thread structure. The objective lens sets are respectively disposed in the lens frames. Each objective lens set includes at least one lens. In an extension direction of the optical axis, a relative position of each lens frame and the substrate changes according to a relative angle of the corresponding external thread structure and internal thread structure. The lens barrel module is disposed on a transmission path of the measuring beam from the second light splitter. The lens barrel module includes a lens barrel, an array eyepiece module, and at least one array light barrier module. The at least one array light barrier module is disposed in the lens barrel. The at least one array light barrier module includes multiple light barriers, and optical axes of the light barriers are respectively coaxial with optical axes of the objective lens sets. The array eyepiece module is connected to an end of the lens barrel and is located between the array objective lens module and the at least one array light barrier module. The array eyepiece module includes multiple eyepiece sets, and optical axes of the eyepiece sets are respectively coaxial with the optical axes of the objective lens sets. The at least one imaging element is disposed on the transmission path of the measuring beam from the lens barrel module and is used to generate imaging information according to the measuring beam.

Several exemplary embodiments accompanied with figures are described in detail below to further describe the disclosure in details.

### BRIEF DESCRIPTION OF THE DRAWINGS

FIG. 1 is a schematic view of an optical interference microscopy system according to an embodiment of the disclosure.

FIG. 2 is a schematic top view of an array objective lens module according to an embodiment of the disclosure.

FIG. 3A is a schematic cross-sectional view along a line A-A′ of the array objective lens module of FIG. 2.

FIG. 3B is a schematic cross-sectional view of an array objective lens module according to another embodiment.

FIG. 4 is a schematic cross-sectional view of a part of the optical interference microscopy system of FIG. 1.

### DETAILED DESCRIPTION OF DISCLOSURED EMBODIMENTS

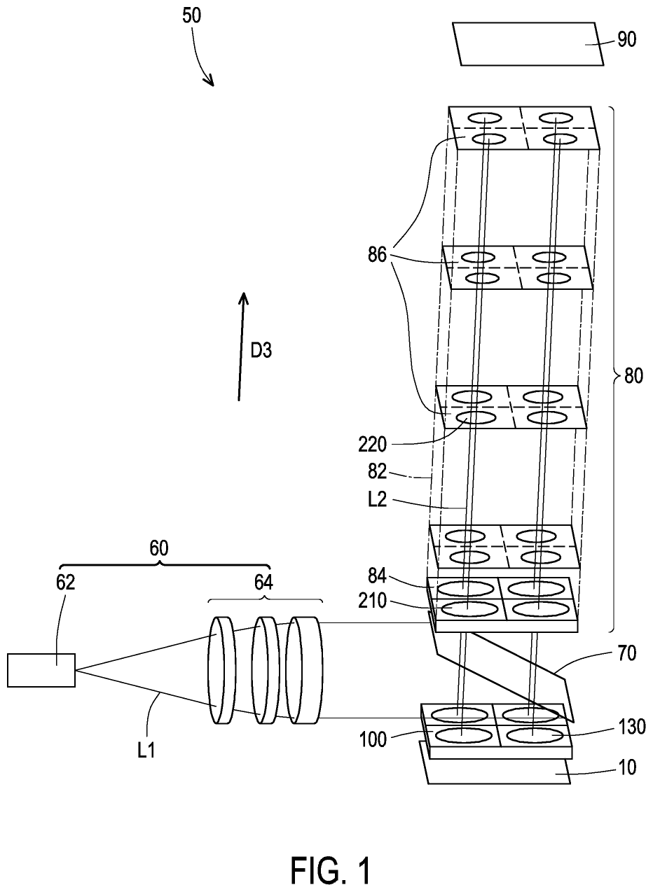

FIG. 1 is a schematic view of an optical interference microscopy system according to an embodiment of the disclosure. Please refer to FIG. 1. The embodiment provides an optical interference microscopy system 50 for imaging and measuring a to-be-measured object 10 (for example, a chip package). The optical interference microscopy system 50 includes a light source module 60, a second light splitter 70, an array objective lens module 100, a lens barrel module 80, and at least one imaging element 90. The optical interference microscopy system 50 is, for example, a white light interference microscope, which is a microscope that displays a surface or an internal structure of the to-be-measured object 10 using the principle of light interference and may be applied to fast and accurate 3D measurement.

The light source module 60 is used to provide an illumination beam L1. Specifically, in the embodiment, the light source module 60 includes a light emitting element 62 and a collimation lens set 64. The light emitting element 62 is a white light emitting element and is used to provide the white illumination beam L1, such as an incandescent lamp, a xenon lamp, a high pressure sodium lamp, a fluorescent lamp, a metal halide lamp, a white light emitting diode, or a white organic light emitting diode, but the disclosure is not limited thereto. The collimation lens set 64 includes, for example, a combination of one or more optical lenses with diopter and is used to collimate the illumination beam L1. In other words, the light source module 60 is a collimated light source.

The second light splitter 70 is disposed on a transmission path of the illumination beam L1 from the light source module 60 and is used to reflect the illumination beam L1 and allow a measuring beam L2 to pass through. The second light splitter 70 is, for example, a spectroscope. When the illumination beam L1 is transmitted to the second light splitter 70, the second light splitter 70 reflects the illumination beam L1 and then the illumination beam L1 passes through the array objective lens module 100 to the to-be-measured object 10, so that the measuring beam L2 with structural information is reflected from the to-be-measured object 10.

The lens barrel module 80 is disposed on a transmission path of the measuring beam L2 from the second light splitter 70. That is, the second light splitter 70 is located between the lens barrel module 80 and the to-be-measured object 10. Specifically, in the embodiment, the lens barrel module 80 includes a lens barrel 82, an array eyepiece module 84, and at least one array light barrier module 86. The lens barrel 82 has two opposite ends inside and an internal accommodating space. The disclosure does not limit the type and the appearance of the lens barrel 82. The array eyepiece module 84 is connected to an end of the lens barrel 82. Specifically, the array eyepiece module 84 is connected to a side of the lens barrel 82 facing the second light splitter 70. The array eyepiece module 84 includes multiple eyepiece sets 210, and each eyepiece set 210 includes at least one lens. Optical axes of the eyepiece sets 210 respectively correspond to optical axes of multiple objective lens sets in the array objective lens module 100. For example, in the embodiment, the array eyepiece module 84 includes four eyepiece sets 210 arranged in a 2×2 array, and the optical axes of the four eyepiece sets 210 respectively correspond to optical axes of four objective lens sets in the array objective lens module 100.

The at least one array light barrier module 86 is disposed in the lens barrel 82, the at least one array light barrier module 86 includes multiple light barriers 220, and optical axes of the light barriers 220 respectively correspond to optical axes of multiple objective lens sets 130 in the array objective lens module 100. Specifically, the optical axes of the light barriers 220 are respectively coaxial with the optical axes of multiple objective lens sets 130. The array eyepiece module 84 is located between the array objective lens module 100 and the at least one array light barrier module 86. The number of the at least one array light barrier module 86 is multiple, and the array light barrier modules 86 are spaced apart from one another. For example, in the embodiment, the number of the array light barrier modules 86 is four, and each array light barrier module 86 includes four light barriers 220 arranged in a 2×2 array. The optical axes of the four light barriers 220 respectively correspond to the optical axes of the four objective lens sets 130 in the array objective lens module 100. Specifically, the optical axes of the four light barriers 220 are respectively coaxial with the optical axes of the four objective lens sets 130. However, in other embodiments, the number of the array light barrier modules 86 may be designed differently according to a spurious ratio, but the disclosure is not limited thereto. By the design of the lens barrel module 80 having the array eyepiece module 84 and the array light barrier module 86 of the embodiment, the array eyepiece module 84 can correspond to the array objective lens module 100 to achieve consistent optical axes, thereby reducing interference signal aberration, and absorbing and suppressing stray light with a via structure of the array light barrier module 86 to maintain good optical interference signals.

The at least one imaging element 90 is disposed on the transmission path of the measuring beam L2 from the lens barrel module 80 and is used to generate imaging information according to the measuring beam L2. The imaging element 90 is, for example, a photosensitive element such as a charge coupled device (CCD) or a complementary metal oxide semiconductor transistor (CMOS). In the embodiment, the number of the imaging element 90 is single. However, in other embodiments, the number of the imaging element 90 may be multiple, and the number thereof is, for example, equal to the number of the objective lens sets 130 of the array objective lens modules 100, but the disclosure is not limited thereto.

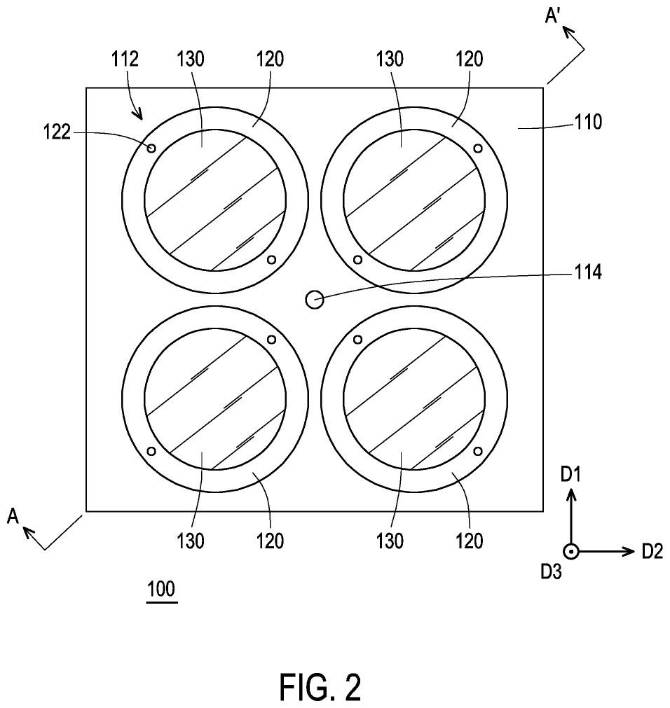

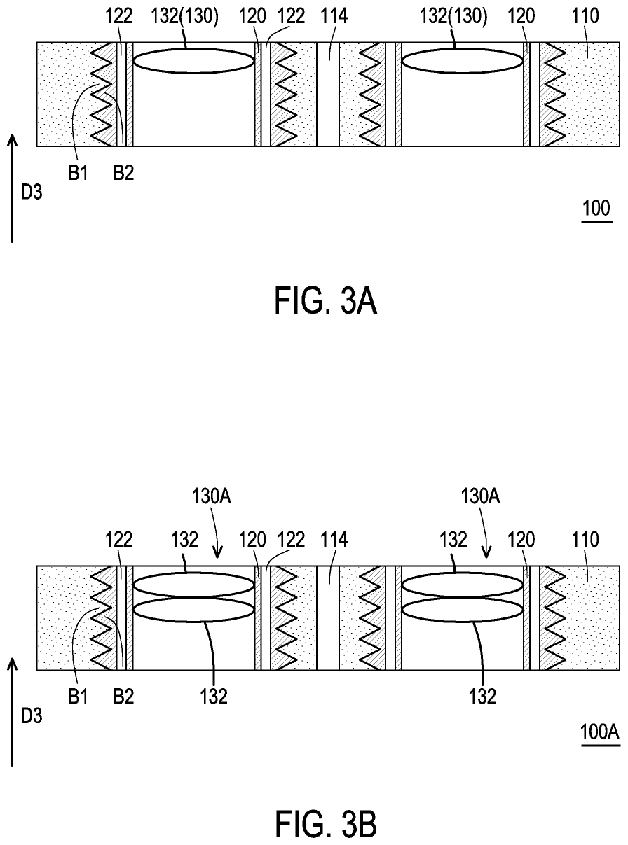

FIG. 2 is a schematic top view of an array objective lens module according to an embodiment of the disclosure. FIG. 3A is a schematic cross-sectional view along a line A-A′ of the array objective lens module of FIG. 2. Please refer to FIG. 1 to FIG. 3A. FIG. 2 and FIG. 3A show partial structures. The array objective lens module 100 is disposed on the transmission path of the illumination beam L1 from the second light splitter 70 and is used to transmit the illumination beam L1 to the to-be-measured object 10 to generate the measuring beam L2. The array objective lens module 100 includes a substrate 110, multiple lens frames 120, and the objective lens sets 130. The substrate 110 includes multiple accommodating vias 112, and each accommodating via 112 includes an internal thread structure B1. In the embodiment, the substrate 100 also includes a calibration via 114 located at the center of symmetry among the accommodating vias 112 and used to allow a calibration beam to pass through. The calibration beam, such as a laser beam, is transmitted from the imaging element 90 toward the array objective lens module 100, and then focus calibration is performed by reflection imaging of the calibration beam reflected by a reflector in the array objective lens module 100.

The lens frames 120 are respectively disposed in the accommodating vias 112. Each lens frame 120 includes an external thread structure B2 adapted to the internal thread structure B1. In other words, each lens frame 120 is adapted to move on the substrate 110 in an extension direction D3 of an optical axis by the thread structures. In the embodiment, each lens frame 120 includes at least one adjustment hole 122 respectively located around the objective lens sets 130 and used to respectively adjust the relative positions of the lens frames 120 and the substrate 110 on the substrate 110.

The objective lens sets 130 are respectively disposed in the lens frames 120, and each objective lens set 130 includes at least one lens 132. The array objective lens module 130 has the optical axis, and in the extension direction D3 of the optical axis, the relative position of each lens frame 120 and the substrate 110 changes according to a relative angle of the corresponding external thread structure B2 and internal thread structure B1. In other words, in the embodiment, by adjusting the rotation angle of the lens frame 120, the position of each lens frame 120 on the substrate 110 may be adjusted to adjust focal plane positions of the objective lens sets 130, so as to effectively improve the coplanarity. According to the design of the embodiment, a maximum distance difference between respective focal planes of the objective lens sets 130 may reach a precision of less than 10 μm, which has better coplanarity and good optical effects. In the embodiment, the number of the lens 132 of each objective lens set 130 is one. However, in other embodiments, the number of lenses of each objective lens set may also be greater than one. For example, FIG. 3B shows an array objective lens module 100A according to another embodiment. In the embodiment, the number of the lenses 132 of each objective lens set 130A is two, but not limited to two, and each objective lens set may also be formed by combining more than two lenses. In addition, in the embodiment, the lens frames 120 and the objective lens sets 130 are arranged in an array in a direction perpendicular to the extension direction D3 of the optical axis. Specifically, in the embodiment, the number of the lens frames 120 and the objective lens sets 130 in a first direction D1 is equal to the number in a second direction D2. The first direction D1 and the second direction D2 are both perpendicular to the extension direction D3 of the optical axis, and the first direction D1 is perpendicular to the second direction D2. For example, in the embodiment, the number of the lens frames 120 and the objective lens sets 130 is, for example, four, and the lens frames 120 and the objective lens sets 130 are arranged in a 2×2 array. In other words, the number of the objective lens sets 130 in the array objective lens module 100, the number of the eyepiece sets 210 in the array eyepiece module 84, and the number of the light barriers in each array light barrier module 86 are the same as each other.

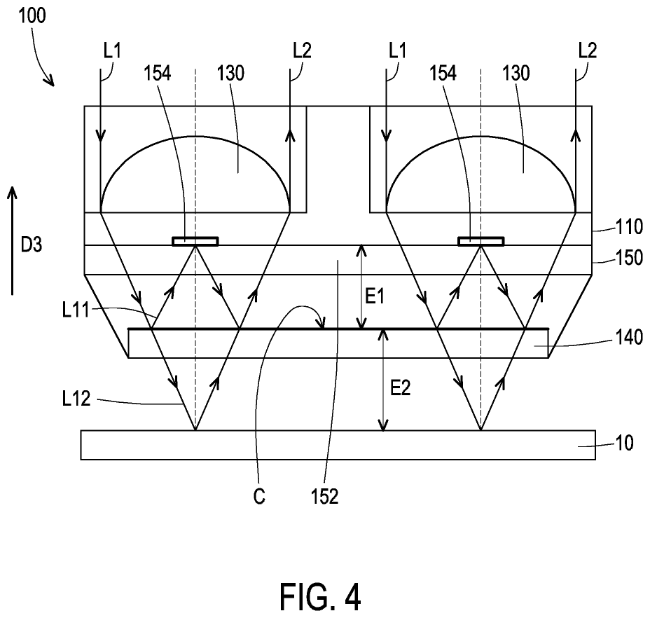

FIG. 4 is a schematic cross-sectional view of a part of the optical interference microscopy system of FIG. 1. Please refer to FIG. 4. In the embodiment, the array objective lens module 100 also includes a first light splitter 140 and a reflector 150. The first light splitter 140 is disposed on the transmission path of the illumination beam L1 from the objective lens sets 130. The illumination beam L1 includes a first beam L11 and a second beam L12. The first light splitter 140 is used to reflect the first beam L11 and allow the second beam L12 to pass through to be transmitted to the to-be-measured object 10. The reflector 150 is disposed between the first light splitter 140 and the substrate 110, and is used to reflect the first beam L11 from the first light splitter 140 to the first light splitter 140, and a part of the first beam L11 forms the measuring beam L2 with a part of the second beam L12. Specifically, in the embodiment, the reflector 150 includes a light transmitting member 152 and multiple reflection patterns 154 formed on the light transmitting member 152. Positions of the reflection patterns 154 respectively correspond to positions of the objective lens sets 130. Specifically, the reflection patterns 154 are respectively located on the optical axes of the objective lens sets 130. For example, the reflection patterns 154 may be respectively formed on specific positions of the light transmitting member 152 using a reflective material and with a yellow light photolithography process. Therefore, compared with traditional non-array lens modules, the embodiment does not need to additionally configure a reflective mirror. On the other hand, the first light splitter 140 includes a light splitting surface C, and a distance E1 from the light splitting surface C to the reflector 150 is equal to a distance E2 from the light splitting surface C to the to-be-measured object 10. When this condition is met, the light L12 reflected by the object will interfere with the reference light L11. The light splitting surface C may be formed by coating.

In other words, the illumination beam L1 forms the first beam L11 and the second beam L12 by the light splitting effect of the first light splitter 140, wherein the first beam L11 is reflected by the light splitting surface C of the first light splitter 140 to reach the reflection patterns 154 of the reflector 150 and be reflected, and then reach the light splitting surface C of the first light splitter 140 again. At this time, a part of the first beam L11 is reflected by the light splitting surface C. By an optical path of the same length, the second beam L12 is reflected back to the light splitting surface C of the first light splitter 140 by the to-be-measured object 10, so that a part of the transmitted second beam L12 interferes with the part of the first beam L11 reflected by the light splitting surface C to generate the measuring beam L2.

In summary, in the array objective lens module and the optical interference microscopy system of the disclosure, the array objective lens module includes the substrate, the lens frames, and the objective lens sets. The lens frames are respectively disposed in the accommodating vias of the substrate, and the objective lens sets are respectively disposed in the lens frames. Each accommodating via includes the internal thread structure, each lens frame includes the external thread structure, and the external thread structure is adapted to the internal thread structure. The array objective lens module has the optical axis, and the relative position of each lens frame and the substrate in the extension direction of the optical axis changes according to the relative angle of the corresponding external thread structure and internal thread structure. In this way, the position of each lens frame on the substrate can be adjusted by the rotation angle of each lens frame, thereby respectively adjusting the focal plane positions of the objective lens sets.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An array objective lens module, having an optical axis and comprising:
a substrate, comprising a plurality of accommodating vias, wherein each of the accommodating vias comprises an internal thread structure;
a plurality of lens frames, respectively disposed in the accommodating vias, wherein each of the lens frames comprises an external thread structure, and the external thread structure is adapted to the internal thread structure; and
a plurality of objective lens sets, respectively disposed in the lens frames, wherein each of the objective lens sets comprises at least one lens, and a relative position of each of the lens frames and the substrate in an extension direction of the optical axis changes according to a relative rotation angle of the corresponding external thread structure and internal thread structure.

2. The array objective lens module according to claim 1, further comprising:
a first light splitter, disposed on a transmission path of an illumination beam from the objective lens sets and used to partially transmit and partially reflect light; and
a reflector, disposed between the first light splitter and the substrate,
wherein the illumination beam passes through the objective lens sets and reaches the first light splitter, the illumination beam comprises a first beam reflected by the first light splitter and a second beam passing through the first light splitter to a to-be-measured object, and the reflector is used to reflect the first beam to the first light splitter.

3. The array objective lens module according to claim 2, wherein the reflector comprises a light transmitting member and a plurality of reflection patterns formed on the light transmitting member, wherein positions of the reflection patterns locate respectively on optical axes of the objective lens sets.

4. The array objective lens module according to claim 2, wherein the first light splitter comprises a light splitting surface, and an optical path distance from the light splitting surface to the reflector is equal to an optical path distance from the light splitting surface to the to-be-measured object.

5. The array objective lens module according to claim 1, wherein the accommodating vias of the substrate are arranged in an array, the lens frames and the objective lens sets are arranged in an array in the accommodating vias, and the extension direction of the optical axis of the array objective lens module is perpendicular to the substrate.

6. The array objective lens module according to claim 5, wherein a number of the lens frames and the objective lens sets in a first direction is equal to the number in a second direction, the first direction and the second direction are both perpendicular to the extension direction of the optical axis of the array objective lens module, and the first direction is perpendicular to the second direction.

7. The array objective lens module according to claim 1, wherein a maximum distance difference between respective focal planes of the objective lens sets is less than 10 μm.

8. The array objective lens module according to claim 1, wherein each of the lens frames further comprises at least one adjustment hole used to rotate the lens frames.

9. The array objective lens module according to claim 1, wherein the substrate further comprises a calibration via, and the calibration via is located at a center of symmetry of the accommodating vias and is used to allow a calibration beam to pass through.

10. An optical interference microscopy system, used to image a to-be-measured object, the optical interference microscopy system comprising:
a light source module, used to provide an illumination beam;
a second light splitter, disposed on a transmission path of the illumination beam from the light source module and used to reflect the illumination beam and allow a measuring beam to pass through;
an array objective lens module, disposed on the transmission path of the illumination beam from the second light splitter to the to-be-measured object, the array objective lens module having an optical axis and comprising:
a substrate, comprising a plurality of accommodating vias, wherein each of the accommodating vias comprises an internal thread structure,
a plurality of lens frames, respectively disposed in the accommodating vias, wherein each of the lens frames comprises an external thread structure, and the external thread structure is adapted to the internal thread structure, and
a plurality of objective lens sets, respectively disposed in the lens frames, wherein each of the objective lens sets comprises at least one lens, and a relative position of each of the lens frames and the substrate in an extension direction of the optical axis changes according to a relative angle of the corresponding external thread structure and internal thread structure;
a lens barrel module, disposed on a transmission path of the measuring beam from the second light splitter, the lens barrel module comprising:
a lens barrel,
at least one array light barrier module, disposed in the lens barrel, wherein the at least one array light barrier module comprises a plurality of light barriers, and optical axes of the light barriers are respectively coaxial with optical axes of the objective lens sets, and
an array eyepiece module, connected to an end of the lens barrel and located between the array objective lens module and the at least one array light barrier module, wherein the array eyepiece module comprises a plurality of eyepiece sets, and optical axes of the eyepiece sets are respectively coaxial with the optical axes of the objective lens sets; and
at least one imaging element, disposed on the transmission path of the measuring beam from the lens barrel module and used to generate imaging information according to the measuring beam.

11. The optical interference microscopy system according to claim 10, wherein the array objective lens module further comprises:
a first light splitter, disposed on the transmission path of the illumination beam from the objective lens sets and used to partially transmit and partially reflect light; and
a reflector, disposed between the first light splitter and the substrate,
wherein the illumination beam passes through the objective lens sets and reaches the first light splitter, the illumination beam comprises a first beam reflected by the first light splitter and a second beam passing through the first light splitter and is used to transmit the second beam to the to-be-measured object, and the reflector is used to reflect the first beam to the first light splitter.

12. The optical interference microscopy system according to claim 11, wherein the reflector comprises a light transmitting member and a plurality of reflection patterns formed on the light transmitting member, wherein positions of the reflection patterns locate respectively on optical axes of the objective lens sets.

13. The optical interference microscopy system according to claim 11, wherein the first light splitter comprises a light splitting surface, and a distance from the light splitting surface to the reflector is equal to a distance from the light splitting surface to the to-be-measured object.

14. The optical interference microscopy system according to claim 10, wherein the accommodating vias of the substrate are arranged in an array, the lens frames and the objective lens sets are arranged in an array in the accommodating vias, and the extension direction of the optical axis of the array objective lens module is perpendicular to the substrate.

15. The optical interference microscopy system according to claim 10, wherein a number of the lens frames and the objective lens sets in a first direction is equal to the number in a second direction, the first direction and the second direction are both perpendicular to the extension direction of the optical axis of the array objective lens module, and the first direction is perpendicular to the second direction.

16. The optical interference microscopy system according to claim 10, wherein a maximum distance difference between respective focal planes of the objective lens sets is less than 10 μm.

17. The optical interference microscopy system according to claim 10, wherein each of the lens frames further comprises at least one adjustment hole respectively located around the objective lens sets and used to rotate the lens frames on the substrate.

18. The optical interference microscopy system according to claim 10, wherein the substrate further comprises a calibration via located at a center of symmetry of the accommodating vias and used to allow a calibration beam to pass through.

19. The optical interference microscopy system according to claim 10, wherein a number of the objective lens sets, a number of the eyepiece sets, and a number of the light barriers are the same as each other.

20. The optical interference microscopy system according to claim 10, wherein a number of the at least one array light barrier module is plural, and the array light barrier modules are spaced apart from each other.

21. The optical interference microscopy system according to claim 10, wherein a number of the at least one imaging element is plural, and a number of the at least one imaging element is equal to a number of the objective lens sets.
